(19) United States
(12) Patent Application Publication
(10) Pub. No.: US 2005/0118225 A1
(43) Pub. Date: Jun. 2, 2005

(54) Snail baits

(76) Inventors: Wolfgang Wirth, Gladbach (DE); Gerhard Baron, Leverkusen (DE); Udo Reckmann, Koln (DE)

Correspondence Address: BAYER CROPSCIENCE LP;Patent Department, 100 BAYER ROAD, PITTSBURGH, PA, 15205-9741, US

(21) Appl. No.: 10/504,100

(22) PCT Filed: Jan. 31, 2003
(86) PCT No.: PCT/EP03/00963

(30) Foreign Application Priority Data
Feb. 13, 2002 (DE) 10205860.1

(51) Int. Cl. A01N 25/08

(52) U.S. Cl. 424/410; 514/22

(57) ABSTRACT

The invention relates to new slug and snail baits consisting of at least one magnesium salt, calcium salt and/or iron salt, lignosulphonate, finely divided cereal meal optional binders and optionally. one or more additives. The invention further relates to a process for the preparation of these slug and snail baits and to their use for controlling terrestrial slugs and snails.

The present invention relates to new slug and snail baits, to a process for their preparation and to their use for controlling slugs and snails.

It has already been disclosed to control terrestrial slugs and snails with the aid of baits which contain feedants and molluscicidal active compounds, such as methiocarb, metaldehyde or metal chelates (cf. DE 35 03 608A, DE 36 12 161A, WO 96-05 728A, WO 97-26 789A, WO 99-25 194A, WO 99-39 576A and WO 00-11 948A). However, the efficacy of these preparations is not always satisfactory.

There have now been found new slug and snail bait consisting of
at least one magnesium salt, calcium salt and/or iron salt,
lignosulphonate,
finely divided cereal meal,
if appropriate binders and
if appropriate one or more additives.

It has furthermore been found that the new slug and snail baits can be prepared by
1) finely grinding a mixture of
   at least one magnesium salt, calcium salt and/or iron salt,
   lignosulphonate, and
   if appropriate additives,
2) treating the resulting premix with
   finely divided cereal meal,
   if appropriate binders and
   if appropriate additives,
3) stirring the resulting homogeneous mixture with such an amount of water that a paste results,
4) extruding and comminuting the paste and
5) drying the product obtained.

Finally, it has been found that the new slug and snail baits are highly suitable for controlling terrestrial slugs and snails.

Surprisingly, the bait according to the invention are markedly more efficient in the control of slugs and snails than the constitutionally most similar, prior-art preparations of the same purpose.

The slug and snail baits according to the invention are characterized by the components listed.

The active component for controlling slugs and snails is in each case a mixture of at least one magnesium salt, calcium salt and/or iron salt in combination with lignosulphonate.

Suitable as salts of the abovementioned metals are, preferably, sulphates, carbonates and phosphates. Examples which may be mentioned are magnesium sulphate, magnesium carbonate, calcium sulphate, calcium carbonate, iron(II) sulphate, iron(III) sulphate, iron(II) hydrogen sulphate, iron(III) hydrogen sulphate, iron(II) hydrogen phosphate, iron(III) hydrogen phosphate, iron(II) hydrogen carbonate, iron(II) phosphate, iron(III) phosphate, iron(II) carbonate and iron(III) carbonate. The salts can exist as the hydrates or in anhydrous form.

Suitable as lignosulphonates are the commercially available salts of lignosulphonic acid. Preferred are alkali metal salts of lignosulphonic acid, such as, for example, sodium lignosulphonate.

Cereal meals which can be present in the slug and snail baits according to the invention are commercially available meals such as wheat flour, rye flour, rice starch and the like. Durum flour and wheat flour are preferred. The meal is present in finely particulate form, preferably in particle sizes of less than 250μ.

Binders which can be present in the baits according to the invention are all customary adhesives which can be used for the preparation of such products. Adhesives which are preferably suitable are modified starch, formaldehyde-releasing substances, optionally partially hydrolyzed polyvinyl acetate and/or molasses.

Modified starch is to be understood as meaning, in the present case, commercially available products of this type. Cold-swelling cornstarch is preferred.

Formaldehyde-releasing substances which can be present are all customary products which are suitable for releasing formaldehyde. Urea/formaldehyde condensates are preferred.

Polyvinyl acetates which can optionally be present in partially-hydrolyzed form, are preferably the products known under the trade names Mowilith® (Clariant) and Mowiol® (Clariant).

Molasses are understood as meaning, in the present case, conventional syrupy mother liquors arising during sugar raffination.

Suitable additives which may be present in the baits according to the invention are, preferably, preservatives, colorants, slug and snail attractants, grinding adjuvants, additives, bittering substances, repellants for warm-blooded species and anticaking agents, and also water and further molluscidal active compounds.

Substances which are suitable as preservatives are all those substances which are conventionally used for this purpose. Preservatives which may be mentioned by preference are benzoyl derivatives such as benzaldehyde, p-hydroxyaldehyde, benzoic acid, methyl p-hydroxybenzoate, p-hydroxybenzoic acid, propyl esters and phenols such as p-nitrophenol, 2-hydroxy-bisphenol and unsaturated carboxylic acids such as sorbic acid and its derivatives.

Substances which are suitable as colorants are all those substances which are conventionally used for this purpose. Examples which may be mentioned are inorganic pigments such as iron oxides, titanium dioxide and Prussian Blue, and inorganic dyestuffs such as anthraquinone, azo and metal phthalocyanin dyestuffs.

Substances which are suitable as slug and snail attractants are all those substances which are conventionally used for this purpose. Examples which may be mentioned are plant extracts and their derivatives, and products of animal origin.

Suitable additives are substances which are suitable for adjusting the pH value in the bait preparations. An example which may be mentioned is citric acid.

Substances which are suitable as grinding auxiliaries are all those substances which are conventionally used for this purpose. Examples which may be mentioned are kaolins, clays, talc, chalk, quartz powder and highly disperse silica.

Repellants for warm-blooded species with a repellent effect on such animals, such as dogs and hedgehogs, are all those substances which are conventionally used for this purpose. An example which may be mentioned is vanillyl nonyl amide.

Substances which are suitable as bittering substances are all those substances which are conventionally used for this purpose. An example which may be mentioned is clenatonium benzoate.

Substances which are suitable as anticaking agents are all those substances which are conventionally used for this purpose and which prevent aggregation and caking. Examples which may be mentioned are moisture-absorbing powders such as kieselguhr, pyrogenic silicas, tricalcium phosphate, calcium silicates, alumina, magnesium oxide, magnesium carbonate, zinc oxide, stearates and fatty amines.

Substances which are suitable as additional molluscicidal active compounds are all those substances which are conventionally used for this purpose. Examples which may be mentioned are methiocarb, metaldehyde and metal salts, if appropriate as a mixture with complexing agents, examples which may be mentioned being chelates of ethylenediaminetetraacetic acid and iron ions and/or copper ions.

The content of the individual components in the slug and snail baits according to the invention can be varied within a certain range. Thus,
The magnesium salt, calcium salt and/or iron salt concentrations are generally between 0.1 and 20% by weight, preferably between 0.2 and 15% by weight,
The lignosulphonate concentrations are generally between 0.5 and 20% by weight, preferably between 1.0% by weight and 15% by weight,
The cereal meal concentrations are generally between 50 and 90% by weight, preferably between 60 and 88% by weight,
The binder concentrations are generally between 2.0 and 20% by weight, preferably between 3.0 and 15% by weight, and
The additive concentrations are generally between 0 and 5.0% by weight, preferably between 0 and 3.0% by weight.

When carrying out the method according to the invention, it is preferred to employ those components which have already been mentioned as preferred components in connection with the description of the slug and snail baits according to the invention.

In practice, diluent which can be employed are inert organic solvents and/or water. Water is preferably employed.

The amounts of the individual components are chosen in such a way that the substances are present, in the slug and snail baits according to the invention, in those weight ratios which have been mentioned above. The amount of water or diluent is chosen in such a way that a paste is formed in step (3) of the process. The amount of water employed is generally between 25 and 35% by weight, preferably between 27 and 34% by weight, based on the remaining constituents. However, the water content is markedly lower in the slug and snail baits according to the invention, since the product, which is initially obtained moist in step (5) of the production process, is still to be dried. Virtually only the residual moisture in the cereal meal remains.

When carrying out the process according to the invention, the temperatures can be varied within a certain range.
Step (1) is generally carried out at temperatures of between 0° C. and 30° C., preferably at room temperature.
Step (2) is generally carried out at temperatures of between 0° C. and 30° C., preferably at room temperature.
Step (3) is generally carried out at temperatures of between 0° C. and 40° C., preferably at between 10° C. and 30° C.
Step (4) is generally carried out at temperatures of between 20° C. and 60° C., preferably at between 30° C. and 50° C.
Step (5) is generally carried out at temperatures of between 20° C. and 90° C., preferably at between 30° C. and 80° C.

Steps (1) to (3) and (5) of the process according to the invention are generally carried out under atmospheric pressure. However, it is also possible to carry out the drying process in step (5) under reduced pressure. Step (4) is generally carried out under elevated pressure, preferably under a pressure of between 30 and 100 bar.

When carrying out the process according to the invention, all the equipment conventionally employed for such processes can be used. Thus, conventional grinding apparatuses, for example air-jet mills, are used for comminuting the material in step (1).

Customary mixers, into which additional substances such as binders and water can be placed during the mixing process, are suitable for the mixing processes in steps (2) and (3). Those which can preferably be used are ploughshare mixers, paddle mixers and twin-screw extruders.

Apparatuses which can be used for the extrusion in step (4) are those conventionally used in the food industry, with the aid of which a paste can be extruded through die plates and subsequently comminuted.

Equipment which can be used for drying the moist product in step (5) is customary equipment for removing moisture from particulate solids. In a preferred embodiment, a procedure is followed in which the moist product is first predried in a fluidized bed and subsequently dried to the desired final moisture level in a separate apparatus.

Specifically, the process according to the invention is carried out in such a way that,
in step (1),
at least one magnesium salt, calcium salt and/or iron salt is treated as a mixture with lignosulphonate and
   if appropriate as a mixture with one or more further molluscidal active compounds and
   if appropriate with additives such as, for example, grinding auxiliaries, preservatives, colorants and the like, and the resulting mixture is ground finely,
in step (2), the resulting premix is mixed with finely divided cereal, binder and, if appropriate, additives, to give a homogeneous product,
in step (3) such an amount of water is added, with mixing and kneading, that a paste is formed,
in step (4), the paste is extruded under pressure and comminuted, and
in step (5), the particulate material is initially predried and then subjected to a final drying step and subsequently cooled to room temperature.

When carrying out the process according to the invention, the size of the slug and snail baits can be varied within a certain range in the manner desired in each case. In general, the paste is comminuted in such a way that pellets or extrudates are formed. The average diameter, and average length, of the particles is generally between 1 and 4 mm, preferably between 1.5 and 3 mm.

The slug and snail baits according to the invention are highly suitable for controlling terrestrial slugs and snails in agriculture and horticulture. The slugs and snails include all those terrestrial slugs and snails which are mostly found in agricultural and horticultural crops as proliphagous pests. Important pests of this type are slugs, such as Arion rufus (red slug), Arion ater and other Arionidae, Limax species, furthermore field slugs such as Deroceras reticulatum and agreste from the Limacidae family, and species of the Milacidae family, and furthermore harmful snails, such as those of the genera Cepaea, Discus, Helicigona and Helicella.

When controlling slugs and snails, the application rate of the baits according to the invention can be varied within a substantial range. In general, between 2 and 15 kg of slug and snail bait are used per hectare, preferably between 3 and 7 kg per hectare.

The slug and snail baits according to the invention can be applied by customary methods, such as, for example, by broadcasting and drilling.

The invention is illustrated by the examples which follow.

### EXAMPLE 1

Preparation of Slug and Snail Bait According to the Invention

A mixture of

| | |
|---|---|
| 92 g | of magnesium sulphate heptahydrate, |
| 45 g | of sodium lignosulphonate, |
| 5 g | of p-nitrophenol, |
| 9 g | blue color pigment, |
| 1 g | of denatonium benzoate and |
| 2 g | of highly disperse silica |

is ground finely at room temperature. In a mixer, the resulting premix is mixed, with stirring and at room temperature, with

| | |
|---|---|
| 2608 g | of durum flour with a particle size of less than 250 μm, |
| 75 g | of cold-swelling corn starch and |
| 15 g | of urea/formaldehyde condensate. |

Thereafter, 210 g of liquid beet molasses are sprayed on at room temperature, while continuing stirring. The resulting mixture is treated with 735 g of water at room temperature and mixed and kneaded until a homogeneous paste has formed. The paste is subsequently extruded at 40° C. and a pressure of 60 bar through a die-plate and the extrudate is comminuted to give pieces 2 to 3 mm in length. The resulting material is initially dried in a fluidized bed at temperatures of between 30° C. and 80° C. and then in a separate dryer at temperatures of between 30° C. and 80° C. In this manner, 3000 g of slug and snail bait are obtained in the form of pellets.

### USE EXAMPLE A

Bare experimental plots with a size of in each case 1 m² are established in the open at a distance of at least 1 m from one another. Two Tagetes patula (marigolds) were planted in the middle of each plot. The entire experimental area was severely infested with Arion and Deroceras slug species.

To control the slugs, the experimental plots were scattered uniformly with the slug and snail bait pellets stated in each case at the application rate stated in each case.

The test was evaluated 6 days after the treatment. The feeding damage on the Tagetes plants caused by slugs and snails determined, and the efficacy of the baits was calculated in %. An efficacy of 0% means the same feeding damage as was observed in the untreated control, while an efficacy of 100% means that no feeding damage was observed.

The preparations used, the application rates and the test results can be seen from the table which follows. The numbers given for the efficacy is the mean of three experiments.

| | Active compound | | |
|---|---|---|---|
| | concentration | Application rate | Efficacy |
| Bait preparation | in % | in g/m² | in % |
| Control: | — | — | 0 |
| Known: | | | |
| Fe PO₄* | 0.37 | 5 | 70 |
| Fe EDTA** | 0.9 | 5 | 70 |
| According to the | | | |
| invention: | | | |
| Ex. 1: MgSO₄/Na- | 0.3 | 5 | 100 |
| Lignosulphonate | | | |

*The iron(III) phosphate was employed in the form of the slug and snail bait which is commercially available under the name Ferramol ® (Neudorff).
**Fe EDTA stands for iron chelate of ethylenediaminetetraacetic acid. Baits based on this complex are disclosed in WO97/26789A

### USE EXAMPLE B

Test slugs: Arion distinctus and Arion hortensis
Test crop: lettuce
Test method: field experiment; experimental site Bury St. Edmunds, UK

The “MgSO₄/ligno”-containing bait formulations are scattered onto 9 m² plots at a rate of 5 g of formulation per m² with 3 replications. The comparison standard Ferramol was likewise applied at 5 g of product/m². The plots were planted with in each case 25 lettuce plants.

The test was evaluated 7 and 14 days after application by determining the feeding damage (% plants with feeding damage) on the test plants. In addition, any symptoms of phytotoxicity were also evaluated.

The efficacy of the test substance is 100% (Abbott method) when no feeding damage has been observed, and 0% when the feeding damage is just as severe as in the control.

| | Active | | | Phytotoxicity |
|---|---|---|---|---|
| | compound | % | % | symptoms |
| | concentration | activity | activity | 1-14 |
| Bait preparation | in g/m² | 7 DAT | 14 DAT | DAT |
| Control | | (5.0) | (60.0) | — |
| (% Plants with feeding | | | | |
| damage) | | | | |
| Known: | | | | |
| Ferramol 0.1 RB | 0.005 | 46.0 | 66.7 | zero |
| According to the | | | | |
| invention: | | | | |
| MgSO₄/Ligno 0.5 RB | 0.015 | 80.0 | 77.8 | zero |
| MgSO₄/Ligno 1.5 RB | 0.075 | 80.0 | 69.5 | zero |

### USE EXAMPLE C

Test slugs: Arion distinctus and Arion hortensis
Test crop: lettuce
Test method: field experiment; experimental site Bury St. Edmunds, UK

The “MgSO₄/ligno”-containing bait formulations are scattered onto 9 m² plots at a rate of 5 g of formulation per m² with 3 replications. The comparison standard Ferramol was likewise applied at 5 g of product/m². The plots were planted with in each case 25 lettuce plants.

The test was evaluated 7 and 14 days after application by determining the feeding damage (% plants with feeding damage) on the test plants. In addition, any symptoms of phytotoxicity were also evaluated.

The efficacy of the test substance is 100% (Abbott method) when no feeding damage has been observed, and 0% when the feeding damage is just as severe as in the control.

| | Active | | | Phytotoxicity |
|---|---|---|---|---|
| | compound | % | % | symptoms |
| | concentration | activity | activity | 1-14 |
| Bait preparation | in g/m² | 7 DAT | 14 DAT | DAT |
| Control | | (5.0) | (60.0) | — |
| (% Plants with feeding | | | | |
| damage) | | | | |
| Known: | | | | |
| Ferramol 0.1 RB | 0.005 | 81.7 | 85.7 | zero |
| According to the | | | | |
| invention: | | | | |
| MgSO₄/Ligno 0.5 RB | 0.015 | 81.7 | 61.6 | zero |
| MgSO₄/Ligno 1.5 RB | 0.075 | 75.3 | 87.3 | zero |

1-3. (canceled)

4. A slug and snail bait consisting of
(a) one or more magnesium salts, calcium salts, and/or iron salts,
(b) a lignosulphonate,
(c) a finely divided cereal meal,
(d) optionally, one or more binders, and
(e) optionally, one or more additives.

5. A process for the preparation of a slug and snail bait according to claim 4 comprising
(1) finely grinding a mixture of
one or more magnesium salts, calcium salts, and/or iron salts,
a lignosulphonate, and
optionally, one or more additives,
to form a premix,
(2) treating the premix with
a finely divided cereal meal,
optionally, one or more binders, and
optionally, one or more additives,
to form a homogeneous mixture,
(3) stirring the homogeneous mixture with an amount of water that results in a paste,
(4) extruding and comminuting the paste, and
(5) drying the extruded and comminuted paste thereby obtained.

6. A method of controlling terrestrial slugs and/or snails comprising applying a slug and snail bait according to claim 4 to the slugs and/or snails or to their habitat.
